(19) United States
(12) Patent Application Publication
(10) Pub. No.: US 2003/0179780 A1
(43) Pub. Date: Sep. 25, 2003

(54) Method of detecting drift between two clocks

(75) Inventors: Anthony Walker, Newport Beach, CA (US); Craig Barrack, Irvine, CA (US)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor V.N. Inc., Irvine, CA (US)

(21) Appl. No.: 10/103,299

(22) Filed: Mar. 20, 2002

(51) Int. Cl. H04J 3/06

(52) U.S. Cl. 370/508; 375/356

(57) ABSTRACT

A method of and apparatus for detecting drift between two clocks is presented. The apparatus comprises a hardware implementation of a clock drift evaluator. The evaluator monitors received packets associated with a data stream, and extracts a time stamp generated by a source clock from each packet. A difference d between the extracted time stamp and the local time is compared against a d_ref value to determine whether the packet was received early or late. On a prescribed schedule, the degree of late and early receipt of packets is compared against a tolerance level to determine whether a relative drift exists between the pacing of the source clock and the pacing of the local clock. The detection of drift between the two clocks provides support for service level guarantees in provisioning data streaming services in packet-switched environments.

### FIELD OF THE INVENTION

The invention relates to data transport between data network nodes in support of data streaming services, and in particular to methods and apparatus for detection of drift between clocks.

### BACKGROUND OF THE INVENTION

Widely known streaming services include: the station-to-station audio communications otherwise known as the telephone service, many-to-many communications otherwise known as audio conferencing, one-way playback communications such as voice-mail, etc. These legacy streaming services are typically provided at very high Quality-of-Service (QoS) levels afforded by the Public Switched Telephone Network (PSTN). The PSTN is a collection of data links and special purpose line switching nodes which interwork to provide circuit-switched dedicated connections between end stations. The high levels of QoS are provided over the PSTN at the expense of sub-optimal use of available data transport bandwidth over a relatively expensive, redundant, inflexible infrastructure when compared to packet-switched networks.

Packet-switching data transport networks, as opposed to the PSTN, are relatively more efficient in utilizing data transport bandwidth: by sharing the available data link bandwidth between multiple communication sessions using a comparatively economical infrastructure. In their infancy, packet-switched data transport networks were used to convey data without making any data transport guarantees and the term “best-effort” data transport was ascribed to them. In spite of the label, the demand for best-effort services, such as electronic mail and web-browsing, provided such a substantial revenue stream that service providers were providing circuit-switched (voice) and packet-switched (data) services in parallel to the same customers.

Revenues generated from the fulfilled demand for data transport services fuelled the development of advanced packet-switched data transport networks rivaling the QoS of circuit-switched networks. Streaming data services may be provided over data transport networks such as but not limited to: internet radio (broadcast audio streaming), audio/video conferencing, internet newscasts (on demand audio/video playback), etc. The success of packet-switched data transport technologies coupled with the demand for data services as well as the pressure to minimize service provisioning costs led to a market push to deliver legacy data streaming services over newer, more modem, more flexible infrastructure of the packet-switched data transport networks.

The migration of legacy data streaming services from circuit-switched technologies to packet-switched technologies is not without challenges. Key differences exist between the two technologies in providing QoS guarantees.

A data streaming service offering having a high QoS benefits from a minimum amount of jitter. Jitter is the variation in the interarrival of data packets at a receiving station. In circuit-switched networks, a dedicated connection is set-up between stations and therefore a minimum amount of jitter can easily be guaranteed. In packet-switched data transport networks however, jitter is incurred as a side effect of processing data packets to ensure efficient utilization of the data transport bandwidth. High levels of jitter leads to discontinuous playback of a data stream.

Data stream playback is further affected by data sampling and playback clock rates. Clock signals used in sampling and playback typically drift due to a variety of factors including but not limited to: inability to minimize tolerances in manufacturing processes, temperature variation, age of the clock, etc. Over time, discrepancies between these clock pacing rates can lead to data overflow/underflow conditions evidenced by a low perceived QoS. Severe discrepancies may ultimately lead to severe data loss.

Another key difference between circuit-switched and packet-switched data networks relates to the topology of the infrastructure. Typically circuit-switched networks have a hierarchical topology, whereas packet-switched networks are for the most part flat.

In a hierarchical topology provisioning environment, master clock signals may be distributed hierarchically. It is customary to use Cesium based time references as the costs involved in provisioning a small number of such expensive units at the top of the interconnection hierarchy can be leveraged over many service subscriptions.

However, in a flat topology provisioning environment, the distribution of master clock signals is a problem which remains unresolved. The flat topology of the packet switched data transport networks tends to suffer from an inability to route master clock signals effectively. A variety of master clock signal distribution protocols have been developed, with others still under development.

Although global time standards exist, such as the Greenwich Mean Time, once clocks are set by it, the clocks will drift necessitating further calibrations. Other solutions include the use of timing signals provided for example by the Global Positioning System (GPS). Such solutions are highly impractical to implement in end stations due to a variety of factors including implementation and deployment cost. GPS receivers also require an unobstructed view of a large sector of the sky which would severely restrict the use of communications equipment implementing such solutions.

There therefore is a need to address problems associated with clock drifts between multiple clocks in supporting data streaming services.

### SUMMARY OF THE INVENTION

In accordance with an aspect of the invention, a clock drift evaluator is provided. The hardware implementation of the evaluator includes a group of components. A time stamp extractor is used to extract time stamp values from each received data packet of a data stream. An arithmetic unit provides a time difference value between the extracted time stamp value and a current local time value for each received data packet. Comparison means are used to compare the time difference value against a reference time value to determine whether each received data packet is one of: an early received packet, an on-time received packet, and a late received packet. Means for providing an evaluation of clock drift based on indications of an extent of early and late packet arrivals.

In accordance with another aspect of the invention, a clock drift evaluation methods provided. The method includes a sequence of steps. A time stamp value generated by a source clock is extracted downstream from the source clock from each received data packet of a monitored data stream. A time difference value is derived between the extracted time stamp value and a current local time value provided by a local clock. A determination is made as to whether each received data packet is one of: an early received packet, an on-time received packet, and a late received packet. A clock drift determination between the source clock ad the local is made by comparing degrees of late and early packet arrivals against an adjustment threshold level.

The detection of drift between clocks provides support for service level guarantees in provisioning data streaming services.

### BRIEF DESCRIPTION OF THE DRAWINGS

The features and advantages of the invention will become more apparent from the following detailed description of the preferred embodiments with reference to the attached diagrams wherein:

FIG. 1 is a schematic diagram showing a comparison between ideal and typical packet arrival rates at a receiver;

FIG. 2 is a schematic diagram showing elements implementing a clock drift detection in accordance with a preferred embodiment of the invention;

FIG. 3 is a schematic diagram showing a normalization table used in accordance with a preferred embodiment of the invention;

FIG. 4 is another schematic diagram showing a normalization table used in accordance with an alternative embodiment of the invention; and

FIG. 5 is a schematic diagram showing a comparison between ideal and corrected playback in accordance with the preferred embodiment of the invention.

It will be noted that in the attached diagrams like features bear similar labels.

### DETAILED DESCRIPTION OF THE EMBODIMENTS

The subject matter of the invention will be presented herein with respect to Voice-over-Internet Protocol (VoIP) technologies which include protocols and hardware adapted to sample, generate, convey and play back telephone quality audio streams. The invention is not limited by the presented embodiments; persons of ordinary skill in the art would recognize that the techniques presented herein may be used for processing other data streams

The Internet Protocol (IP) is an Open Systems Interconnection (OSI) Layer 3 protocol used for conveying packets over packet-switched data networks end-to-end. The VoIP technologies interwork with the IP protocol to provision the conveyance of telephone quality audio streams end-to-end.

Depending on the VoIP implementation, end-to-end data transport may be provisioned over the OSI Layer 4 connectionless Universal Datagram Protocol (UDP) or the connection-oriented Transport Control Protocol (TCP).

In of itself the IP protocol does not make any guarantees as to the delivery of data packets, nor does it have support for providing service level guarantees. Typically VoIP implementations make use of other data transport protocols to provide support for service level guarantees. Many such data transport protocols have been devised, most of which are still under development. The Real-Time Protocol (RTP) is an example of a data transport protocol attempting to control transport latencies in conveying data packets over packet-switched data transport networks.

The subject matter presented herein will be described making reference to the RTP protocol used in combination with the UDP/IP data transport protocols. The combination provides for the conveyance of RTP/UDP/IP encapsulated data packets at reduced overheads. Other combinations of protocols may be used without limiting the invention.

In order to convey data streams in support of real-time communications, it is important for sender and receiver stations (with respect to a data stream) to agree on audio signal sampling and playback rates. In the absence of reliance on a master clock signal, the use of the RTP protocol provides for the inclusion of time stamp values encapsulated with data stream samples in the data packets conveyed.

The following issues must be taken into account in sampling, generating, conveying and playing back voice samples for telephone service provisioning:

Typical telephone sessions include: playback-only where the receiving station listens to voice prompts for example, station-to-station in which both stations generate and convey voice samples, and audio-conferences in which a stream of voice samples generated at one of the stations is multicasted to all other participant stations in the audio-conference. Therefore multiple clock signal sources exist;

It is preferred that each sampling source clock use a different, randomly selected, starting time value from which to advance the sampling clock values in order to prevent data encryption attacks. The RTP protocol provides a packet sequence number which also increments from a randomly generated starting value to prevent data encryption attacks. Encryption when necessary in communications is provided by a higher layer protocol outside the scope of the subject matter described herein;

The sampling and playback clocks must agree on, and be aware of, a unit of time used to express values of the time stamp conveyed in the RTP header. The time stamp value is typically expressed in terms of integer stamping intervals, each sampling interval having a duration of 125 μs; and

Correct playback timing can only be ensured if the sampling rate and the playback rate are substantially the same (i.e. well within tolerances of the human hearing system). The sampling and playback rates, in the absence of a master clock are dependent on the respective pacing rates thereof.

A person of ordinary skill in the art would understand that both the sampling clock and the playback clock may develop a slightly different pacing rate. The development of a slightly different pacing rate by a clock is referred to, in the art, as clock drift.

Regardless of which one of the sampling or playback clocks develops the slightly different pacing rate, it is more convenient to regard the sampling clock as an absolute clock while the playback clock is regarded as the one deviating from the absolute. Only relative clock drift is important. Making this choice, reduces each one of the above presented telephone session configurations to a combination of playback-only telephone sessions. A station-to-station telephone session corresponds to two playback-only telephone sessions. In an audio-conference, sampled audio data can be regarded as being sent to each one of the other participants in the audio-conference in individual playback-only telephone sessions.

Therefore clock drift detection is to be performed downstream of the VoIP source stations by devices including, but not limited to, VoIP receiving station related equipment.

Therefore only three relevant pieces of information are available at a data network node providing VoIP services downstream from a source:

the sequence number of the VoIP-RTP data packet (IP packets are not necessarily conveyed in sequence);

the time stamp value held in the RTP header representative of the relative time at which the data samples were generated (expressed in multiples of 125 μs); and

the current time value of the data network node at which voice sample data packets are received (expressed in multiples of 125 μs).

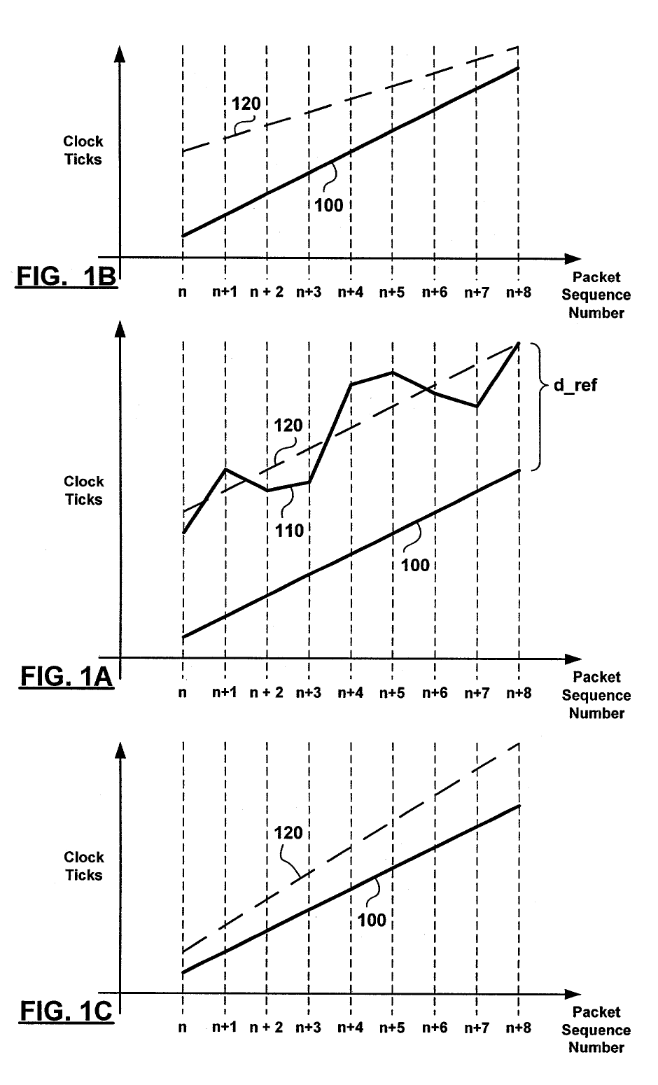

FIG. 1 is a diagram showing a comparison between an ideal and typical pacing of two clocks relative to one another as observed at a station receiving a data stream for real-time playback.

FIG. 1A is representative of the ideal situation in which no perceptible relative drift exists between the sampling and the playback clock. The graph 100 shows a monotonically increasing variation of received timestamp values with each received packet n+i in the data stream.

The graph 110 is representative of a variation in the interarrival time between received packets n+i of a data stream as measured in 125 μs clock ticks at the receiving station. The graph 110 is not smooth due to jitter being incurred by the packets n+i while in transport between the source and the receiving station. It is possible, as mentioned above, for the packets associated with the stream to arrive out of sequence. This is schematically shown in the diagram wherein the n+2 packet has arrived before the n+1 packet.

On a small time scale, the level of jitter overshadows the clock drift as the jitter variation level may be much greater than the degree of clock drift. The jitter is assumed to be generated by packet processing which, for stable packet-switched data transport equipment and therefore packet-switched data transport networks has a bound average value.

Therefore, by monitoring received packet arrival times over the long term, relative clock pacing rate variations may be determined. A running average of the arrival times of the packets n+i can be calculated at the receiving end. The graph 120 corresponds to the running average associated with the arrival times of the packets n+i. In the ideal scenario shown, there is no perceptible relative clock drift, the graphs 100 and 120 are parallel and distanced apart by a constant time duration labeled “d_ref”.

FIG. 1B is representative of a scenario in which the source clock is perceived at the receiver station to run faster due to a perceived fast receipt of packets. A fast receipt of packets may be determined from a shallower slope of the graph 120 compared to that of graph 100. This of course may also be due to an actual slow running clock associated with the receiving end. As mentioned above, regardless which clock drifts, the source clock is assumed to be absolute and the receiver clock is assumed to run comparatively slower.

In such a case, if the receiver clock is used to play back the audio stream, the playback would tend to be slow in comparison with the rate at which the samples were generated and therefore would tend to play back less samples then are received per unit time. The situation may lead to saturation of the data stream and buffer overflow conditions. The listener would be experiencing a relatively slow playback interspersed with discontinuous choppy speech as packets are dropped from overflown buffers and therefore absent from the playback. As mentioned above, the human hearing system is tolerant to some extent but severe clock drifts can lead to discomfort.

FIG. 1C is representative of a scenario in which the source clock is perceived by the receiver end to run slow due to a perceived slow receipt of packets. A slow receipt of packets may be determined from a steeper slope of the graph 120 compared to that of graph 100. This of course may also be due to an actual fast running clock associated with the receiving end. As mentioned above, regardless which, source clock is assumed to be absolute and the receiver clock is assumed to run comparatively faster.

In such a case, if the receiver clock is used to play back the audio stream, the playback would tend to be fast in comparison with the rate at which the data stream samples were generated and therefore the receiver would tend to play back more samples then are received per unit time. The situation may lead to starvation of the data stream and buffer underflow conditions. The listener would be experiencing relatively fast playback interspersed with relatively long periods of uncomfortable silence as subsequently received packets catch up with the playback. The human hearing system is tolerant to some extent but severe clock drifts can lead to discomfort.

In accordance with the invention, an attempt is made at detecting, with the intent of subsequently correcting for, clock signal drift between the source clock and the playback clock. The description herein will focus on detecting clock drift while only providing reference to methods of correcting for clock drift. Correcting for clock signal drift is a topic of research onto its own. Methods and apparatus of detecting the clock drift will be presented hereinbelow.

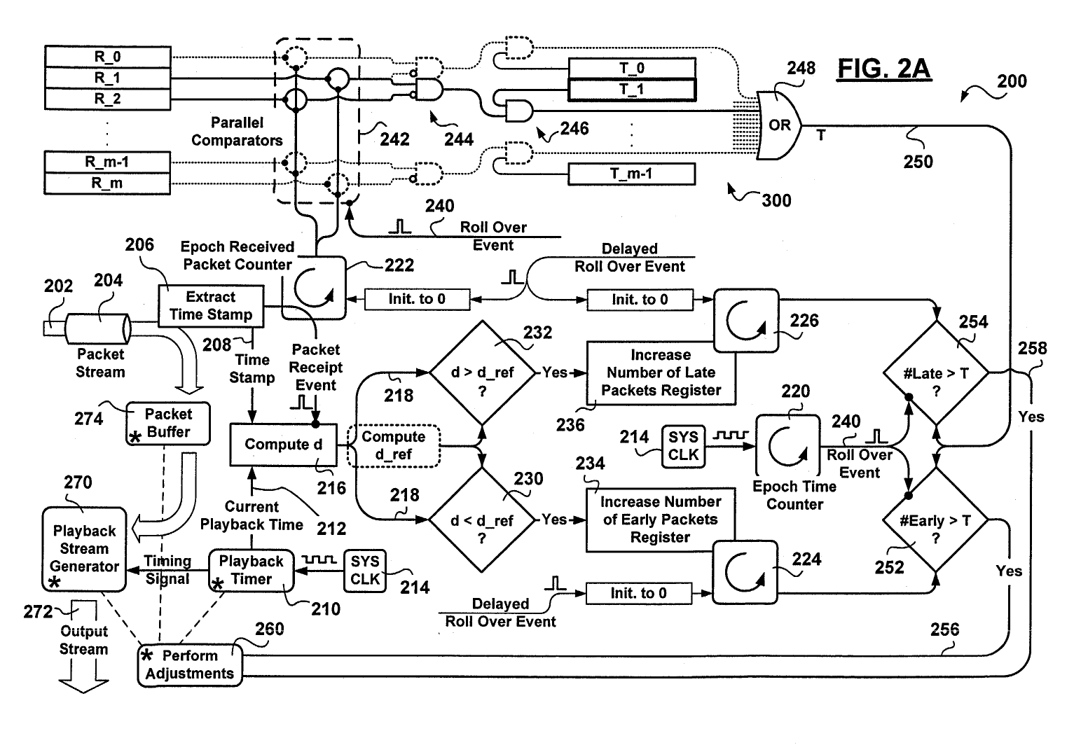

FIG. 2A is a schematic diagram showing elements implementing clock drift detection. In accordance with the preferred embodiment of the invention a hardware clock drift evaluator 200 is provided.

Persons of ordinary skill in the art are well aware that the running average alluded to above as well as performing divisions in calculating the average are hard to implement in hardware. In making use of a running average, the provided result would: give an indication that a relative clock drift exists, the type of drift, and the extent of the clock drift.

In accordance with the preferred embodiment of the invention, implementing a running average provides more information than is necessary as the extent of the clock drift is to be contained by detecting indications of, and the type of, clock drift as soon as possible.

In accordance with an exemplary hardware implementation of the evaluator 200 presented herein, a relatively long time interval referred to as an epoch is chosen to include in the evaluation a number of received packets in order to smooth out the jitter in evaluating clock drifts. Typical voice sampling methods generate a voice sample every 125 μs. Human hearing tolerances mentioned above are in the order of 1 ms. If the epoch evaluation period is too short, then the output provided by the evaluator 200 is highly correlated to and in effect measures the jitter. If the epoch evaluation period is too long, then the playback is subject to the discomfort mentioned above. Field trials have shown that epoch times of 1-2 s strike a balance between a comfortable playback under general prevailing conditions while minimizing clock drift detection computational overheads incurred. In accordance with another embodiment of the invention the duration of each epoch may be chosen to optimize QoS parameters.

In accordance with a preferred embodiment of the invention, the clock drift is evaluated based on detected discrepancies between d_ref, and calculated differences “d” between the time stamp value and the arrival time of each received packet of a data stream monitored by the evaluator 200.

A packet stream 202 is received at a data network equipment evaluating clock drifts via an input port 204. The packet stream 202 is distinguished from other data packets conveyed via the port 204 using preferable methods described in co-pending United States patent application bearing Ser. No. 10/033,498 entitled “Generic Header Parser Providing Support for Data Transport Protocol Independent Packet Voice Solutions” filed by the Applicant on Dec. 27^{th}, 2001. The corresponding time stamp value 208 is extracted 206 from each received data packet in the stream 202.

A playback timer 210 provides the current playback time 212. The current playback time 212 may be derived from a system clock 214.

Based on the time stamp value 208 and the current playback time 212, a subtractor 216 computes the difference d 218 therebetween for each received packet.

The hardware implementation makes use of a group of counters all of which are reset to zero on start up as well as at the expiration (240) of each epoch. The group of counters includes:

an epoch counter 220 whose roll over condition signals the end of an epoch,

a counter 222 associated with the extraction step 206 tallying the total number of packets received during an epoch,

a counter 224 tallying the number of packets received early during an epoch, and

a counter 226 tallying the number of packets received late during an epoch.

In accordance with the preferred embodiment of the invention, the indication of the clock drift is derived from:

the percentage of packets received late during an epoch normalized to the total number of received packets during the epoch, and

the percentage of packets received early during an epoch normalized to the total number of received packets during the epoch.

The value d (128) is provided, preferably in parallel, to decision blocks 230 and 232. For each newly calculated value d: the decision block 230 determines whether the corresponding packet has been received early, and decision block 232 determines whether the corresponding packet has been received late.

The decision that the packet was received early, that is d<d_ref, is used to increase 234 the counter 224 by one. The decision that the packet was received late, that is d>d_ref, is used to increase 236 the counter 226 by one. Packets arriving on time (d=d_ref) contribute only to the total number of packets received during the epoch counted by counter 222.

The process of inspecting packets continues for the duration of each epoch until the epoch time counter 220 rolls over.

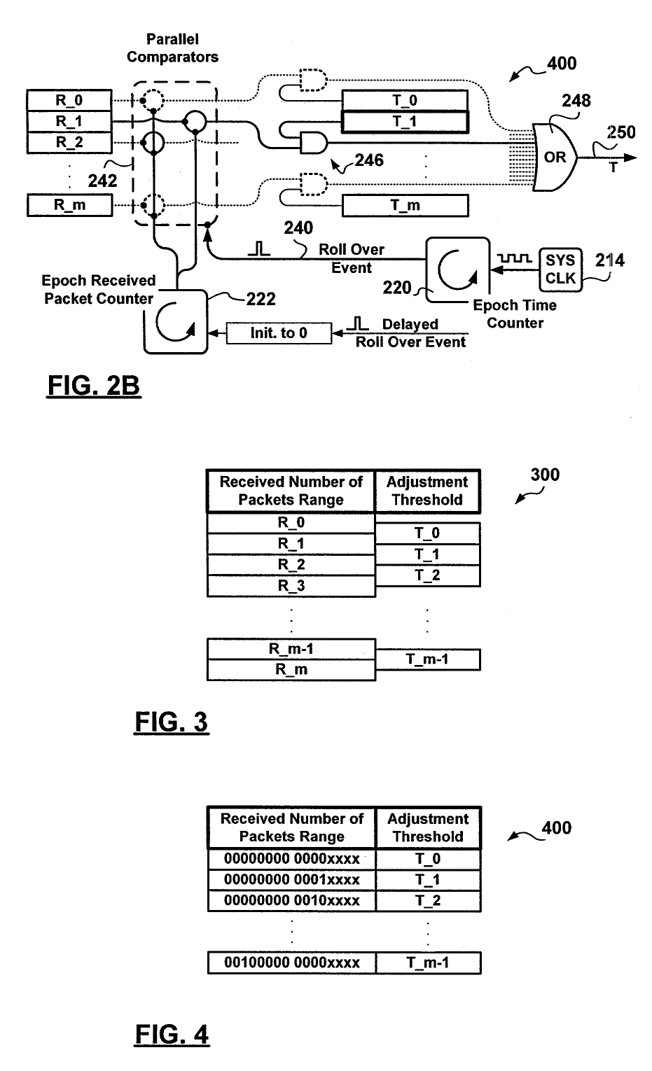

The value of counter 222 holding the total number of packets received during the epoch is used as an index into a table 300. The table 300 is used to provide normalized adjustment thresholds to generate an indication of clock drift. The table includes: a group of values R_{—}0 to R_m representative of amounts of total number of packets typically received during an epoch, and a related group of values T_{—}0 to T_m−1 representative of corresponding normalized adjustment thresholds. Different implementations may be used as shown at 300 in FIG. 3 and at 400 in FIG. 4. A balance must be struck between the number of table entries related to implementation cost and the accuracy of the normalization provided.

In accordance with the invention, the normalization with respect to the total number of packets received, takes into account periods of time in which no samples are conveyed in connection with the monitored data stream due to silence at the originating station.

In accordance with a preferred implementation of the invention, on the roll over event 240, the value of the counter 222 is loaded in parallel to a group of comparators 242. A comparator 242 is used for each R entry in the table 300. Each comparator 242 determines whether the total number of received packets during the epoch just completed, is greater than the corresponding R value. Consequently, a sequential number of comparators 242 will output a logic high value and a remaining sequential number of comparators 242 will output a logic low value.

The output of the comparators 242 are provided to a bank of AND gates 244 in sequential pairs. One of the inputs of each AND gate 244 is negated such that only one the AND gate 244 will output a logic high value. The AND gate 244 which outputs the logic high value corresponds to immediately higher and immediately lower R values about the total number of packets received during the epoch just elapsed.

The outputs of the AND gates 244 are ANDed 246 with corresponding T values and the resulting outputs are ORed together 248. Because only one AND gate 244 outputs a logic high signal, the corresponding T value is output 250 by the OR gate 248.

In accordance with another implementation of the invention, the granularity of the entries in table 400 is specified by single R entries having omitted least significant digits. A range of total number of received packets (222) would correspond to an R entry. As shown in FIG. 2B, the comparators 242 would match the total number of received packets to an R entry directly (i.e. the most significant digits of the respective binary representations thereof would match) therefore not necessitating the use of AND gates 244.

The arrangement of comparators, gates and table registers described in the above implementations provides the correct normalized adjustment threshold T value in one clock cycle derived from the roll over event 240.

The normalized adjustment threshold value T (250), corresponding to the total number of received packets for the epoch just elapsed, is provided to two decision blocks 252 and 254. Each one of the decision blocks 252/254 determines 256/258 whether the number of early/late received packets exceeds the adjustment threshold T respectively.

The outputs 256 and 258 are provided to a clock drift compensation block 260 to perform the necessary adjustments in playing back the audio stream.

A copy of the roll over event 240 is delayed and subsequently used to initialize all counters to zero to ready the evaluator 200 for the next epoch.

A variety of compensation techniques may be implemented including: adjusting the pacing rate of the playback timer 210, signaling a playback stream generator 270 when to drop or add samples to the output stream 272, dropping/inserting packets in a packet buffer 274, etc. The compensation of clock drifts is beyond the scope of the present description and may even include providing a feedback to the source.

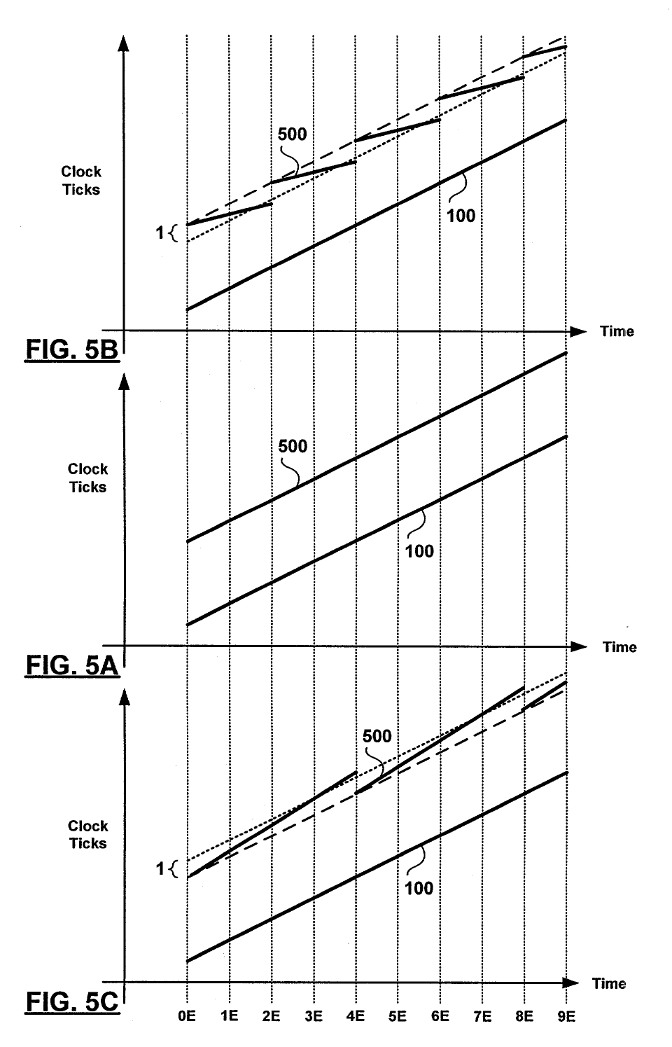

FIG. 5 is a schematic diagram showing a comparison between an ideal and corrected playback in accordance with the preferred embodiment of the invention.

FIG. 5A is representative of the case in which no perceptible clock drift exists between the sampling clock and the playback clock where the variations in received time stamp values 100 and playback times 500 have parallel linear graphs.

FIG. 5B is representative of corrected fast playback 500 due to clock drift which is adjusted, in accordance with the example shown, every other epoch.

FIG. 5C is representative of corrected slow playback 500 due to clock drift which is adjusted, in accordance with the example shown, every fourth epoch.

The value of d_ref must be provided in order to use the above presented methods and apparatus. A multitude of methods may be used to derive the value of d_ref without departing from the spirit of the invention.

In accordance with an exemplary embodiment of the invention, an average d ref value is obtained from the first couple of calculated d values. A simple way of implementing such an average d_ref value is to accumulate 2\hat{ }n d values and shift the binary representation of the result n times to discard least significant bits. Situations may arise in which the selected d values for the calculation of d_ref are severely contaminated by jitter in which case the resultant d_ref value is inappropriate. The calculation of d_ref may be performed on the first packets received after clock drift adjustments to eventually settle on a d_ref value. Care must be taken so as not to create conditions for positive feedback.

In accordance with another embodiment of the invention, the value of d_ref is determined from ping times between the data network equipment performing the clock drift evaluation and the data network equipment encapsulating time stamps in the data packets of the monitored data stream. Again averaging of ping times may be performed without division by shifting n times binary representations of 2\hat{ }n accumulated ping times.

As mentioned above, it is to be understood that although the invention was presented with respect to the processing of a one-way data stream, the invention applies equally well to all call scenarios.

Further it is understood that any number of devices may be used between the data stream generation station and the playback station including data stream mixers. In many instances the data stream mixers re-stamp the data packets with new time stamp values generated by source clocks at the mixing device. The invention therefore need not necessarily be limited to monitoring sampling and playback clock pacing rates and may also be used to monitor source clock pacing rates. The invention need not necessarily be implemented only in equipment associated with a receiving station; an input end of other devices such as mixers may also use the apparatus and implement methods presented herein. As such clock drift determination may be performed between any source clock and a local clock associated with the evaluator 200.

The embodiments presented are exemplary only and persons skilled in the art would appreciate that variations to the above described embodiments may be made without departing from the spirit of the invention. The scope of the invention is solely defined by the appended claims.

I/we claim:

1. A clock drift evaluator comprising:
a. a time stamp extractor for extracting time stamp values from each received data packet of a data stream, the time stamp values being generated by a source clock;
b. an arithmetic unit providing a time difference value between the time stamp value extracted from each received data packet and a current local time value derived from a local clock;
c. comparison means comparing the time difference value against a time reference value to determine whether each received data packet is one of: an early received packet, an on-time received packet, and a late received packet;
d. means for providing an evaluation of clock drift based on indications of an extent of early and late packet arrivals.

2. A clock drift evaluator as claimed in claim 1, wherein the evaluator further comprises:
a. an epoch counter advanced with time, the roll over event of which marks an evaluation epoch;
b. a counter tallying a total number of received packets during the evaluation epoch; and
c. means for providing an adjustment threshold normalized to the total number of received packets during the evaluation epoch.

3. A clock drift evaluator as claimed in claim 2, wherein the means for providing the adjustment threshold further comprises: a lookup table having a plurality of adjustment threshold entries, each adjustment threshold entry corresponding to a range of total number of received packets during the evaluation epoch.

4. A clock drift evaluator as claimed in claim 3, wherein the lookup table further comprises paired range entries denoting each one of the ranges corresponding to each one of the plurality of adjustment threshold entries.

5. A clock drift evaluator as claimed in claim 4, wherein the lookup table further comprises a comparator for each one of the paired range entries, the comparator comparing the total number of received packets during the evaluation epoch with the range entry to determine whether the total number of received packets exceeds the value specified by the range entry.

6. A clock drift evaluator as claimed in claim 5, wherein the lookup table further comprises an AND gate for each one of the pair of range entries, the AND gate receiving as a first input the output of the comparator corresponding to one of the paired range entries and as a second input the negated output of the comparator corresponding to the other one of the paired range entries, to output a logic high value when the total number of received packets during the epoch is within the denoted range, wherein the output of the AND gate is subsequently used to output the corresponding adjustment threshold.

7. A clock drift evaluator as claimed in claim 3, wherein the lookup table further comprises a range entry denoting each one of the ranges, each range entry holding a specification thereof specifying most significant digits only.

8. A clock drift evaluator as claimed in claim 7, wherein the lookup table further comprises a comparator for each one of the range entries, the comparator comparing the total number of received packets during the evaluation epoch with the range entry to determine whether the total number of received packets equals the value specified by the range entry, wherein the output of the comparator is subsequently used to output the corresponding adjustment threshold.

9. A clock drift evaluator as claimed in claim 2, wherein the mans for providing the evaluation of clock drift further comprises:
a. a late received packet counter for counting instances of late packet arrivals to provide the indication of the extent of late packet arrivals;
b. an early received packet counter for counting instances of early packet arrivals to provide the indication of the extent of early packet arrivals; and
c. a pair of drift evaluation comparators, each one of the drift evaluation comparators, triggered by the roll over event, comparing the indication of the extent of late packet arrivals and the extent of early packet arrivals against the normalized adjustment threshold.

10. A clock drift evaluator as claimed in claim 1, wherein the clock drift evaluator further comprises means for generating the reference time value.

11. A method of detecting clock drift between two clocks comprising the steps of:
a. extracting a time stamp value generated by a source clock from each received packet of a monitored data stream downstream from the source clock;
b. deriving a time difference value between the stamp value and a current local time value provided by a local clock;
c. determining whether each received data packet is one of: an early received packet, an on-time received packet, and a late received packet;
d. determining whether clock drift exists between the source clock and the local clock by comparing degrees of late and early packet arrivals against an adjustment threshold level.

12. A method as claimed in claim 11, wherein determining whether clock drift exists between the source clock and the local clock, the method further comprises a step of: comparing the degree of late and early received packets against a normalized adjustment threshold level.

13. A method as claimed in claim 11, wherein determining whether clock drift exists between the source clock and the local clock, the method further comprises a step of: determining, on a prescribed schedule, whether clock drift exists between the source clock and the local clock.

14. A method as claimed in claim 13, wherein the prescribed schedule comprises of time periods and in comparing the degrees of late and early packet arrivals against the adjustment threshold, the method further comprises a prior step of: providing the adjustment threshold normalized to a total number of data packets received during a time period.

15. A method as claimed in claim 11, wherein determining whether the received packet is one of: an early received packet, an on-time received packet, and late received packet, the method further comprises a step of:
comparing the time difference value against a reference time value.

16. A method as claimed in claim 11, wherein determining whether the received packet is one of: an early received packet, an on-time received packet, and late received packet, the method further comprises steps of:
a. tallying a number of early packet arrivals to specify the degree of early packet arrivals; and
b. tallying a number of late packet arrivals to specify the degree of late packet arrivals.

17. A method as claimed in claim 15, wherein the method further comprises step of: generating the d_ref value.

18. A method as claimed in claim 17, wherein generating the reference time value, the method further comprises a step of: averaging a plurality of time difference values.

19. A method as claimed in claim 18, wherein averaging a plurality of time difference values, the method further comprises a step of: performing bit operations in averaging the plurality of time difference values.

20. A method as claimed in claim 19, wherein performing bit operations in averaging the plurality of time difference values, the method further comprises steps of:
a. accumulating 2\hat{ }n (2ⁿ) time difference values into a register holding a binary representation thereof; and
b. shifting the binary representation n times to discard least significant digits therefrom.

21. A method as claimed in claim 17, wherein generating the reference time value, the method further comprises a step of: averaging a plurality of half ping times.

22. A method as claimed in claim 21, wherein averaging a plurality of half ping times, the method further comprises a step of: performing bit operations in averaging the plurality of half ping times.

23. A method as claimed in claim 22, wherein performing bit operations in averaging the plurality of half ping times, the method further comprises steps of:
a. accumulating a number 2\hat{ }n (2ⁿ) of ping times into a register holding a binary representation thereof; and
b. shifting the binary representation n+1 times to discard least significant digits therefrom.
